(19) United States
(12) Patent Application Publication
(10) Pub. No.: US 2012/0120363 A1
(43) Pub. Date: May 17, 2012

(54) LIQUID CRYSTAL DISPLAY ELEMENT

(76) Inventors: Shoichi Ishihara, Osaka (JP); Mitsuhiro Murata, Osaka (JP); Takehisa Sakurai, Osaka (JP); Tadashi Ohtake, Osaka (JP); Shuichi Kozaki, Osaka (JP)

(21) Appl. No.: 13/387,205

(22) PCT Filed: Mar. 8, 2010
(86) PCT No.: PCT/JP2010/053813

§ 371 Date: Jan. 26, 2012

(30) Foreign Application Priority Data
Jul. 28, 2009 (JP) 2009-175704
Jan. 15, 2010 (JP) 2010-006690

(51) Int. Cl. G02F 1/1343

(52) U.S. Cl. 349/141

(57) ABSTRACT

The present invention provides a liquid crystal display element that can be driven at a low threshold voltage. A liquid crystal display element of the present invention includes: a pair of substrates; and a liquid crystal layer sealed between the pair of substrates, wherein the liquid crystal layer contains liquid crystal molecules that are aligned perpendicularly to at least one substrate face of the pair of substrates when a voltage is applied, the at least one of the pair of substrates comprises a pair of comb-shaped electrodes, the at least one of the pair of substrates comprises a polymer film on a face contacting the liquid crystal layer, and the polymer film is made of a polymer material having a CF₂ bond.

### TECHNICAL FIELD

The present invention relates to a liquid crystal display element. More particularly, the present invention relates to a liquid crystal display element suitable for a display mode of controlling light transmitting through a liquid crystal layer by transversely bend-aligning liquid crystal molecules in the liquid crystal layer by voltage application.

### BACKGROUND ART

Liquid crystal display elements (hereinafter, abbreviated as LCD) are low-profile, lightweight, and low-power-consumption display devices and have offered many uses such as cellular phones, PDAs, car navigation systems, personal computer monitors, televisions, and information displays such as information boards in train stations and outdoor billboards.

Current LCDs perform display by controlling the alignment of liquid crystal molecules by application of an electric field, changing the polarization of light transmitting through a liquid crystal layer, and adjusting the amount of light passing through a polarizer. Most of the LCD display performances are determined by the alignment of liquid crystal molecules in voltage application, and the size and direction of an applied electric field. Display modes of LCDs are roughly divided into two modes: a vertical alignment mode and a horizontal alignment mode. Regarding display modes, Table 1 shows the alignment of liquid crystal molecules when no voltage is applied, the direction of an applied electric field, and display characteristics that change with the alignment and direction.

| | | Direction of applied | |
|---|---|---|---|
| Display mode | Liquid crystal alignment when no voltage is applied | electric field | Characteristics |
| Twisted Nematic mode | Liquid crystal molecules near a substrate interface are | Vertical electric field | Easy production (low cost) |
| | horizontal to substrates, and twist in a 90° direction | | High light use efficiency |
| | from an upper substrate to a lower substrate. | | (high transmittance) |
| In-plane Switching mode | Aligned horizontally to substrates (liquid crystal | Transverse electric | Ultrawide viewing angle |
| | molecules near an interface face in opposite directions | field | |
| | in an upper substrate and a lower substrate: anti- | | |
| | parallel) | | |
| Optically self-Compensated | Aligned horizontally to substrates (liquid crystal | Vertical electric field | Fast response |
| Birefringence mode | molecules at an interface face in the same direction in | | Wide viewing angle |
| | an upper substrate and a lower substrate: parallel) | | |
| Multi-domain devided | Aligned vertically to substrates (liquid crystal | Vertical electric field | High contrast |
| Vertical Alignment mode | molecules incline in multiple directions when a voltage | | Wide viewing angle |
| | is applied) | | |

The above display modes have been already put in practical use, and various devices have been made for further improvement in characteristics. Patent Document 1, for example, discloses a method of using an alignment film formed from a solid particulate-containing liquid crystal alignment agent varnish, or an alignment film in which solid particulates are dispersed on the surface in order to achieve a rapid and sure transition from spray alignment to bend alignment at a low voltage, as a device for an OCB mode.

Patent Document 2, for example, proposes, as an application of a TN mode, a transverse electric field type TN mode in which pair of electrodes are formed not in each of a pair of substrates but in one of them to generate a transverse electric field, and transition between a twist state and a non-twist state is achieved.

Further, Patent Document 3, for example, proposes a GH (Guest-Host) mode which eliminates the need for or reduces a polarizer by using a liquid crystal layer which is different from the above modes and contains a dichroic dye.

However, a display mode that satisfies all the characteristics, which are a wide viewing angle, high contrast, and fast response, has not been developed yet.

In contrast, the following has been conventionally investigated. Patent Document 4, for example, proposes a display mode in which the alignment of liquid crystal molecules with positive dielectric anisotropy which are vertically aligned in no voltage application is controlled with multiple electrodes which are disposed in parallel to one another on the same plane. Patent Documents 5 and 6, for example, propose a display mode in which two electrodes are formed in parallel to each other in a lower substrate of two substrates, the liquid crystal molecules of the liquid crystal layer are aligned perpendicularly to the two substrates when no electric field is applied, a radiating electric field is formed between the two electrodes, and thereby right and left liquid crystal molecules are symmetrically aligned based on the central region between the two electrodes to give viewing angle characteristics.
[Patent Document 1]
Japanese Kokai Publication No. 2002-131754
[Patent Document 2]
Japanese Kokai Publication No. 2002-268088
[Patent Document 3]
Japanese Kokai Publication No. 2001-108996
[Patent Document 4]
Japanese Kokai Publication No. Sho-57-618
[Patent Document 5]
Japanese Kokai Publication No. Hei-10-333171
[Patent Document 6]
Japanese Kokai Publication No. Hei-11-24068

### DISCLOSURE OF THE INVENTION

The present inventors have investigated a display mode (hereinafter, also referred to as a VA-IPS mode) that specifies the alignment direction of liquid crystal molecules located between a pair of electrodes to transverse bend alignment by generating an arch transverse electric field using the pair of electrodes provided in the same substrate while maintaining high contrast by vertical alignment using a nematic liquid crystal having positive dielectric anisotropy (p (positive) type) as a liquid crystal material. Hereinafter, the background of the present invention will be described by exemplifying the VA-IPS mode. The present invention is not limited to the VA-IPS mode.

FIG. 1 is a perspective view schematically showing the configuration of a typical VA-IPS mode. As shown in FIG. 1, a VA-IPS mode liquid crystal display element has a pair of substrates 1 and 2, and a liquid crystal layer 3 is sealed between the pair of substrates 1 and 2. The pair of substrates 1 and 2 include transparent substrates 11 and 12, respectively, as main components, and have vertical alignment films 13 and 14 on faces contacting the liquid crystal layer 3 side. As a result, when no voltage is applied to the liquid crystal layer 3, all of the liquid crystal molecules 15 exhibit vertical alignment (homeotropic alignment). A voltage can be applied to the liquid crystal layer 3 by a pair of comb-shaped electrodes 16 formed in one of the pair of substrates 1 and 2. Light is transmitted or blocked by polarizers 17 and 18 disposed on faces on a side opposite to the liquid crystal layer side on the transparent substrates 11 and 12.

According to such a basic configuration, as in the liquid crystal display elements shown in Patent Documents 5 and 6, a bend electric field is formed by voltage application, and two domains whose director directions are symmetrical to each other are formed in a region between a pair of electrodes of a liquid crystal layer. Therefore, wide viewing angle characteristics can be obtained.

In contrast, more specifically, the present inventors have already found that a high transmittance, wide viewing angle, and fast response are compatible when an electrode width of comb-shaped electrodes, an electrode spacing, and a liquid crystal layer thickness are optimized.

FIG. 2 is a view schematically showing equipotential curves in cells of a VA-IPS mode when a voltage of 7 V is applied. As shown in FIG. 2, liquid crystal molecules in application of a threshold voltage or higher are aligned under the influence of an electric field strength distribution and constraints from an interface. FIG. 3 is a view schematically showing alignment of the liquid crystal molecules in the cells of the VA-IPS mode shown in FIG. 2. The liquid crystal molecules in voltage application continuously changes from homeotropic alignment to transverse bend alignment. Thus, in the drive of the VA-IPS mode, the liquid crystal molecules in the liquid crystal layer exhibit transverse bend alignment, and enable a fast response also in response between tones. FIG. 4 is a view schematically showing movement of the liquid crystal molecules in the cells of the VA-IPS mode shown in FIG. 2 when a voltage is applied. As liquid crystals rotate, the liquid crystals flow downward (in the arrow direction in FIG. 4) so as to draw two circles symmetrical to each other in each domain. Therefore, the liquid crystals do not interfere with each other, which enables a fast response.

The characteristics of the VA-IPS mode include a fast response, wide viewing angle, and high contrast. FIG. 5 shows a transmittance distribution. FIG. 5 is a view schematically showing a liquid crystal alignment distribution and a transmittance distribution in cells of a VA-IPS mode when a voltage of 10 V is applied. As shown in FIG. 5, liquid crystal molecules located just above a pair of electrodes are less likely to be affected by the change in an electric field. In addition, liquid crystal molecules located in a central region between the respective electrodes farthest from the respective electrodes are also less likely to be affected by the change in an electric field. Therefore, vertical alignment of these liquid crystal molecules are maintained. As a result, as shown in the curves of FIG. 5, dark lines are formed along an electrode formation part and a central part between electrodes, resulting in transmittances lower than those of other display modes.

One possible technique of increasing transmittance is a technique of increasing the width of a non-electrode portion of a liquid crystal layer. However, this technique poses new problems of a high threshold voltage and a high drive voltage, and also causes a problem of the steepness of voltage-transmittance characteristics in the vicinity of a half tone. FIG. 6 is a graph showing voltage-transmittance characteristics of cells of a typical VA-IPS mode. The solid line is a graph wherein the electrode width L of the comb-shaped electrode is 4 μm, the electrode spacing S is 4 μm, and the thickness d of the liquid crystal layer is 4 μm. The dashed line is a graph wherein the electrode width L of the comb-shaped electrode is 4 μm, the electrode spacing S is 12 μm, and the thickness d of the liquid crystal layer is 4 μm. The liquid crystal used in order to give the graphs is a mixed liquid crystal MLC-6418 (produced by Merck & Co., Inc.). As shown in FIG. 6, a high transmittance needs a large electrode spacing S. However, this results in a high drive voltage, and therefore, for example, is not suitable for cellular phones requiring a low-voltage drive, leading to limited application.

In contrast, FIG. 7 is a graph showing voltage-transmittance characteristics in a VA-IPS mode when an electrode spacing S is fixed to 4 μm in comparison with voltage-transmittance characteristics in other display modes. In any mode, the liquid crystal material is a nematic liquid crystal ZLI-4792 (produced by Merck & Co., Inc.), and the thickness d of the liquid crystal layer is 4 μm. The electrode width L of the comb-shaped electrode is 4 μm, and the electrode spacing S is 4 μm. As shown in FIG. 7, the VA-IPS mode has a threshold voltage higher than other display modes, and poses an important problem of reduction in drive voltage compared with other display modes.

The present invention was made in view of the above problems and it is an object of the present invention to provide a liquid crystal display element that can be driven at a low threshold voltage.

The present inventors have made efforts to reduce the drive voltage in a transverse electric field mode, for example, in which the initial inclination is vertical alignment, and noted the movement of liquid crystal molecules in applying a voltage to the liquid crystal molecules in the VA-IPS mode. They have found that the VA-IPS mode is a display mode in which liquid crystal molecules fall down to the center of a non-electrode portion in applying an electric field, and the liquid crystal molecules fall down inside from right and left in the non-electrode portion that contributes to transmittance; therefore, the strain energy of the electric field is large in the vicinity of the region including the above dark line, and the VA-IPS mode exhibits a threshold voltage higher than other display modes in which molecular rotation occur uniformly in all the regions.

The present inventors have also found that the rotation of the liquid crystal molecules is affected not only by the above factors but also by the interface constraint, Fredericks threshold, alignment angle of the liquid crystal molecules, electric field strength, and electric field direction, and the steepness of the transmittances in the vicinity of the threshold is determined by the balance of these factors.

As a result of earnest investigations, the present inventors have found that reduction in constraint (anchoring energy) in a polar angle direction at an interface with a liquid crystal layer of a substrate is effective in reduction in threshold voltage.

FIG. 8 is a conceptual view showing behavior of liquid crystal molecules near an interface between a liquid crystal layer and a substrate in a VA-IPS mode not adopting the present invention. FIG. 9 is a conceptual view showing behavior of liquid crystal molecules near an interface between a liquid crystal layer and a substrate in a VA-IPS mode adopting the present invention. As shown in FIG. 8, generally, in the VA-IPS mode, all the liquid crystal molecules 15 in voltage-OFF state show vertical alignment. In voltage-ON state, vertical alignment is maintained in the first row of the liquid crystal molecules 15 closest to the substrate 11 and the electrode 16, and the second row of the liquid crystal molecules 15 closest thereto inclines. As shown in FIG. 9, according to the present invention, the first row of the liquid crystal molecules 15 closest to the substrate 11 and the electrode 16 also inclines.

The present inventors have further investigated a specific method of reducing anchoring energy of a substrate in a polar angle direction at an interface with a liquid crystal layer. As a result, the present inventors have found that if the polymer film at the interface with the liquid crystal layer is (i) made of a polymer material having a CF₂ bond, (ii) made of a polymer material having a CF₃ bond in a side chain end, (iii) made of a polymer material having an SiO bond, or (iv) comprises, on its surface, multiple depressions each having a depth of 10 nm or more but 100 nm or less, the anchoring energy of a substrate in the polar angle direction can be effectively reduced at the interface with the liquid crystal layer. Thus, the above-mentioned problems have been admirably solved, leading to completion of the present invention.

That is, the present invention relates to a liquid crystal display element (hereinafter, also referred to as a first liquid crystal display element of the present invention), including: a pair of substrates; and a liquid crystal layer sealed between the pair of substrates, wherein the liquid crystal layer contains liquid crystal molecules that are aligned perpendicularly to at least one substrate face of the pair of substrates when no voltage is applied, the at least one of the pair of substrates comprises a pair of comb-shaped electrodes, the at least one of the pair of substrates comprises a polymer film on a face contacting the liquid crystal layer, and the polymer film is made of a polymer material having a CF₂ bond.

The present invention also relates to a liquid crystal display element (hereinafter, also referred to as a second liquid crystal display element of the present invention), including: a pair of substrates; and a liquid crystal layer sealed between the pair of substrates, wherein the liquid crystal layer contains liquid crystal molecules that are aligned perpendicularly to at least one substrate face of the pair of substrates when no voltage is applied, the at least one of the pair of substrates comprises a pair of comb-shaped electrodes, the at least one of the pair of substrates comprises a polymer film on a face contacting the liquid crystal layer, and the polymer film is made of a polymer material having a CF₃ bond in a side chain end.

The present invention also relates to a liquid crystal display element (hereinafter, also referred to as a third liquid crystal display element of the present invention), including: a pair of substrates; and a liquid crystal layer sealed between the pair of substrates, wherein the liquid crystal layer contains liquid crystal molecules that are aligned perpendicularly to at least one substrate face of the pair of substrates when no voltage is applied, the at least one of the pair of substrates comprises a pair of comb-shaped electrodes, the at least one of the pair of substrates comprises a polymer film on a face contacting the liquid crystal layer, and the polymer film is made of a polymer material having an SiO bond.

The present invention also relates to a liquid crystal display element (hereinafter, also referred to as a fourth liquid crystal display element of the present invention), including: a pair of substrates; and a liquid crystal layer sealed between the pair of substrates, wherein the liquid crystal layer contains liquid crystal molecules that are aligned perpendicularly to at least one substrate face of the pair of substrates when no voltage is applied, the at least one of the pair of substrates comprises a pair of comb-shaped electrodes, the at least one of the pair of substrates comprises a polymer film on a face contacting the liquid crystal layer, and the polymer film is made of an inorganic material and comprises, on its surface, multiple depressions each having a depth of 10 nm or more but 100 nm or less.

The present invention is different from Patent Documents 1 to 3 of the art discussed above in the following points.

In Patent Document 1, solid particulates are dispersed on the surface of an alignment film in an OCB mode, and these solid particulates are the core of transition from spray alignment to bend alignment, whereby the initialization voltage is reduced for the transition. That is, it is presumed that in the portion in which particulates are present on the surface of the alignment film, alignment in a micro region is disrupted, twist alignment is partially formed, and bend transition is facilitated. This is different from the subject matter of the invention of weakening the anchoring energy and thereby reducing the transition voltage.

Patent Document 2 discloses that if a transverse electric field application mode and an a-TN mode are combined, and the anchoring strength of an interface with a liquid crystal layer on a transparent substrate side having a pair of electrodes is larger than the anchoring strength of an interface with the liquid crystal layer on a transparent substrate side not having a pair of electrodes, a TN liquid crystal is rotated by an electric field while twisted alignment is maintained, and switching at a voltage lower than that of a typical TN mode can be achieved.

However, the anchoring strength here shows anchoring in an azimuth angle direction but does not mention anchoring in a polar angle direction. In addition, in this mode, problematically, it is not easy to control the boundary area of each domain, and a high contrast display cannot be achieved.

In Patent Document 3, in the GH mode, adjustment of anchoring with a chemical adsorption film is more likely to move liquid crystal molecules, leading to a fast response. Patent Document 3 discloses a vertical alignment film made of a chemical adsorption film having a fluorocarbon group in a long chain end, but does not disclose the resulting effect of low voltage. Generally, the chemical adsorption film is a super-thin film, and the voltage loss caused by a film is small, resulting in low voltage.

Hereinafter, the first to fourth liquid crystal display elements of the present invention are described in detail.

The first to fourth liquid crystal display elements of the present invention each includes a pair of substrates and a liquid crystal layer sealed between the pair of substrates. The liquid crystal layer is filled with liquid crystal molecules whose alignment is controlled by applying a certain voltage. One or both of the pair of substrates are provided with lines, electrodes, semiconductor devices, and the like. With such substrates, a voltage is applied to the liquid crystal layer, which controls alignment of the liquid crystal molecules.

The liquid crystal layer contains liquid crystal molecules that are vertically aligned to at least one substrate surface of the pair of substrates when no voltage is applied. If the initial alignment of liquid crystal molecules is vertical alignment, light in black display can be blocked effectively.

At least one of the pair of substrates has a pair of comb-shaped electrodes. The entire configuration of the comb-shaped electrodes is not particularly limited as long as the comb-shaped electrodes have a shaft of a comb and comb teeth that project from the shaft on a plane. When one of the pair of comb-shaped electrodes is a pixel electrode that is provided in each pixel and to which a signal voltage is applied, and the other comb-shaped electrode is a common electrode to which a common voltage maintained at a fixed voltage is applied, for example, an electric field (for example, an electric field in a transverse direction) can be formed in each pixel based on an image signal supplied to a pixel electrode.

At least one of the pair of substrates has a polymer film on a face contacting the liquid crystal layer. The polymer film is preferably a vertical alignment film in which the inclination of the liquid crystal molecules close to the surface of the polymer film is adjusted to approximately 90° (90°±0 to 4°) in a polar direction. The initial alignment may be derived from the polymer film material or the structure of the polymer film.

In the first liquid crystal display element of the present invention, the polymer film is made of a polymer material having a CF₂ bond. In the second liquid crystal display element of the present invention, the polymer film is made of a polymer material having a CF₃ bond in a side chain end. Preferably, the polymer film has a CF₂ bond, and a CF₃ bond in a side chain end. Also preferably, F atom content per repeating unit of the polymer material having a CF₂ bond and/or the polymer material having a CF₃ bond in a side chain end is 5% by weight or more. If the polymer material contains F (fluorine) atoms, the surface energy of the polymer film decreases, and therefore the anchoring energy to liquid crystal molecules also decreases. In addition, F atoms can reduce the affinity for ionic impurities, and therefore can prevent formation of an electric double layer on the surface of the polymer film.

In the third liquid crystal display element of the present invention, the polymer film is made of a polymer material having an SiO bond. The anchoring energy to liquid crystal molecules on the surface of a polymer film having an SiO bond is one or more digits smaller than the anchoring energy to liquid crystal molecules on the surface of a polymer film not having an SiO bond. Therefore, use of a polymer material having an SiO bond enables reduction in the anchoring energy to liquid crystal molecules.

Larger Si (silicon) atom content contributes to lower threshold voltage. Therefore, the Si (silicon) atom content per repeating unit of the polymer material is preferably 5% by weight or more. In consideration of formation of a polymer film and alignment regulation to liquid crystal molecules, the Si atom content per repeating unit of the polymer material is more preferably 30% by weight or less.

In the fourth liquid crystal display element of the present invention, the polymer film is made of an inorganic material and has, on its surface, multiple depressions each having a depth of 10 nm or more but 100 nm or less. The polymer film in this case is not an organic film, such as polyimide generally used as an alignment film, but an inorganic film. The polymer film has fine irregularities satisfying the above range on its surface. When such an inorganic film is used, the anchoring energy can be reduced by one or more digits smaller than when an organic film is used. The inorganic film is not superior to the above polyimide film in uniformity, but can vertically align liquid crystal molecules.

In the first to fourth liquid crystal display elements of the present invention, the liquid crystal molecules are preferably nematic liquid crystal molecules having positive dielectric anisotropy. As a result, when a voltage is applied to a liquid crystal layer, the liquid crystal molecules are aligned along an electric filed direction, whereby a wide viewing angle can be obtained. When a voltage is applied to the liquid crystal layer, a liquid crystal molecule group forms an arch shape, for example.

The configuration of the liquid crystal display element of the present invention is not especially limited as long as it essentially includes such components. The liquid crystal display device may or may not include other components.

### EFFECT OF THE INVENTION

According to the present invention, even a liquid crystal display element (for example, a transverse electric field system liquid crystal display element) in which the initial inclination is vertical alignment can be driven at a low voltage.

### BRIEF DESCRIPTION OF THE DRAWINGS

FIG. 1 is a perspective view schematically showing the configuration of a VA-IPS mode of the present invention or a typical VA-IPS mode.

FIG. 2 is a view schematically showing equipotential curves in cells of a VA-IPS mode of the present invention or a typical VA-IPS mode when a voltage of 7 V is applied.

FIG. 3 is a view schematically showing alignment of the liquid crystal molecules in the cells of the VA-IPS mode shown in FIG. 2.

FIG. 4 is a view schematically showing movement of the liquid crystal molecules in the cells of the VA-IPS mode shown in FIG. 2 when a voltage is applied.

FIG. 5 is a view schematically showing a liquid crystal alignment distribution and a transmittance distribution in cells of a VA-IPS mode of the present invention or a typical VA-IPS mode when a voltage of 10 V is applied.

FIG. 6 is a graph showing voltage-transmittance characteristics of cells of a VA-IPS mode of the present invention or a typical VA-IPS mode.

FIG. 7 is a graph showing voltage-transmittance characteristics in a VA-IPS mode when an electrode spacing S is fixed to 4 μm in comparison with voltage-transmittance characteristics in other display modes.

FIG. 8 is a conceptual view showing behavior of liquid crystal molecules near an interface between a liquid crystal layer and a substrate in a VA-IPS mode not adopting the present invention.

FIG. 9 is a conceptual view showing behavior of liquid crystal molecules near an interface between a liquid crystal layer and a substrate in a VA-IPS mode adopting the present invention.

FIG. 10 is a view schematically showing the relationship between an electric field direction of a liquid crystal display element and a transmission axis of a polarizer according to Embodiment 1.

FIG. 11 is a cross-sectional view schematically showing the liquid crystal display element according to Embodiment 1.

FIG. 12 is a graph showing voltage-transmittance characteristics of liquid crystal elements of Example 1 and Comparative Example 1 at room temperature.

FIG. 13 is a cross-sectional schematic view showing the configuration of a liquid crystal display element according to Embodiment 8.

FIG. 14 is a plan schematic view showing the configuration of the liquid crystal display element according to Embodiment 8.

### MODES FOR CARRYING OUT THE INVENTION

The present invention will be described in more detail hereinafter based on embodiments with reference to the drawings. Here, the present invention is not restricted to these embodiments.

### Embodiment 1

A liquid crystal display element of Embodiment 1 is a VA-IPS mode liquid crystal display element in which, when no voltage is applied, an electric field in a transverse direction (direction parallel to a substrate face) is applied to a liquid crystal layer containing a p-type nematic liquid crystal (nematic liquid crystal having positive dielectric anisotropy) aligned perpendicularly to the substrate face, and liquid crystal molecules in the liquid crystal layer are transferred to the bend alignment in the transverse direction.

Further provided with a drive circuit, a backlight (lighting installation), and the like, the liquid crystal display element of Embodiment 1 can be used for cellular phones, PDAs, car navigation systems, personal computer monitors, televisions, and information displays such as information boards in train stations and outdoor billboards.

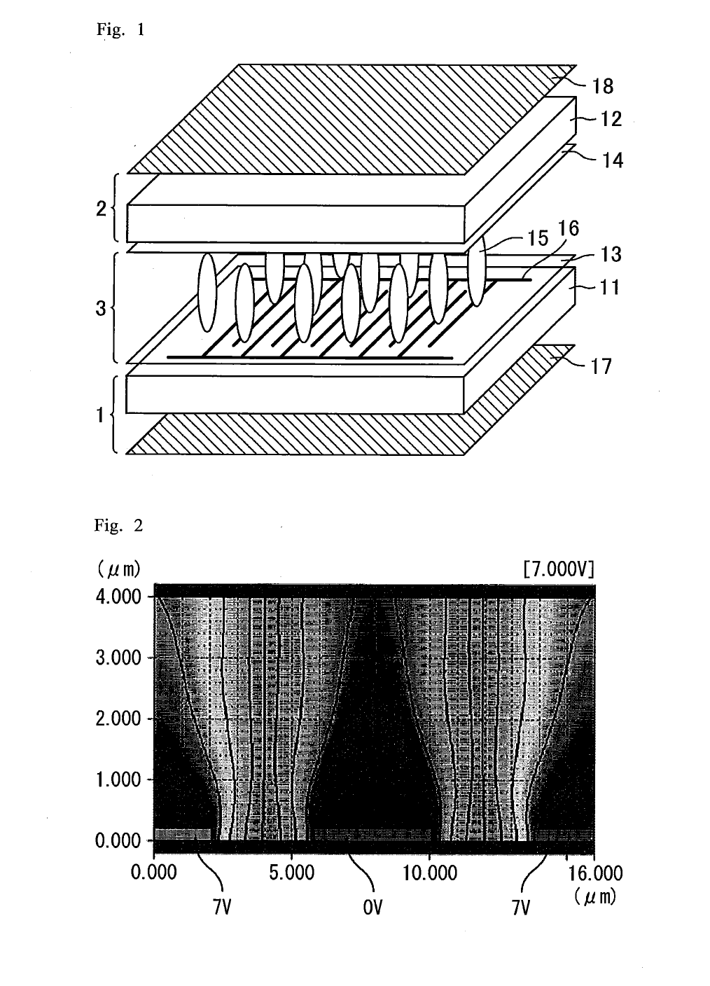

FIG. 1 is a perspective view schematically showing the liquid crystal element of Embodiment 1. As shown in FIG. 1, the liquid crystal display element of Embodiment 1 is provided with a pair of substrates which includes: an array substrate 1 mainly including a transparent substrate 11; and a counter substrate 2 mainly including a transparent substrate 11. A liquid crystal layer 3 containing p-type nematic liquid crystal molecules 15 is sealed between a TFT substrate 1 and the counter substrate 2. The liquid crystal molecules 15 in the liquid crystal layer 3 are aligned perpendicularly to the main surfaces of the substrates 1 and 2 (homeotropic alignment).

The array substrate 1 has a pair of comb-shaped electrodes 16 for applying a constant voltage to the liquid crystal layer 3. A polymer film (alignment film) 14 is provided on faces on which the array substrate 1 and the counter substrate 2 contact the liquid crystal layer 3.

In Embodiment 1, the polymer film 14 may be, for example, a polyimide vertical alignment film including a polymer material having a chemical structure of formula (1). In formula (1), the polymer material 14 has a CF₃ group in a side chain end of a diamine compound (main chain).

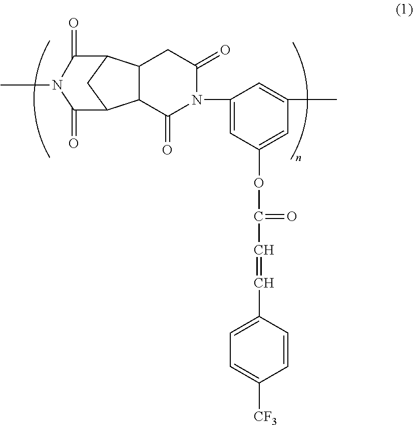

(In the formula, n represents the number of the repeated structures in the parenthesis, and is a positive integer.)

The polymer film 14 in Embodiment 1 may have a CF₃ group in a side chain end in the chemical structure, and examples thereof include, in addition to polyimide resins, acrylate resins, polystyrene resins, polyester resins, and polypropylene resins.

The pair of comb-shaped electrodes are a pixel electrode and a common electrode, and mainly include comb teeth. The comb teeth of the pixel electrode are parallel to the comb teeth of the common electrode, and they are mutually alternately engaged with a space therebetween. The pixel electrode is an electrode disposed in each pixel unit in a display region, and an image signal is supplied to the pixel electrode. In contrast, the common electrode is an electrode whose entirety is conducting irrespective of boundaries of pixels, and a common signal is supplied to the common electrode.

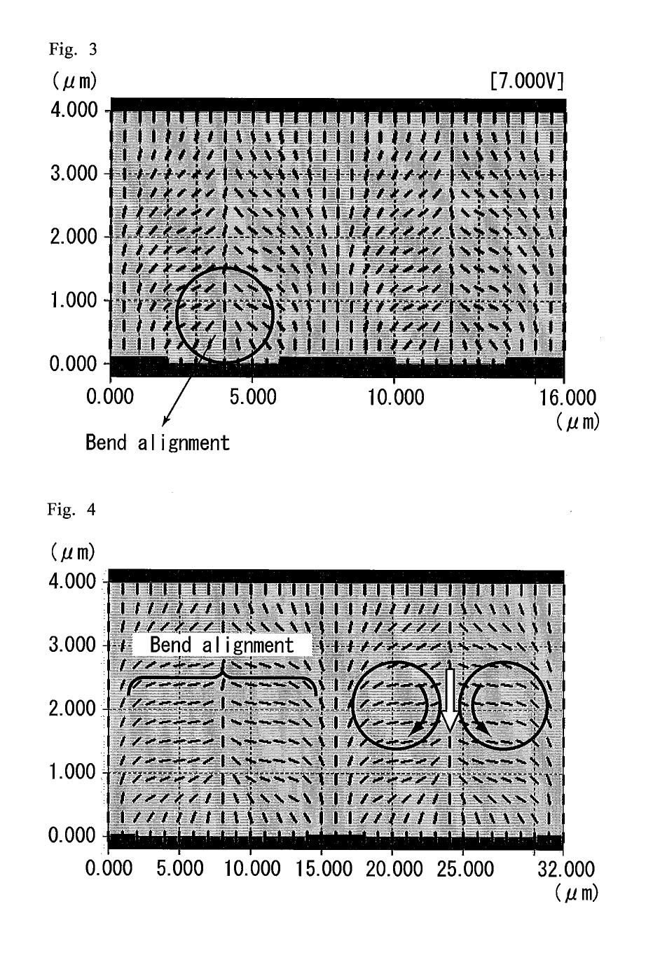

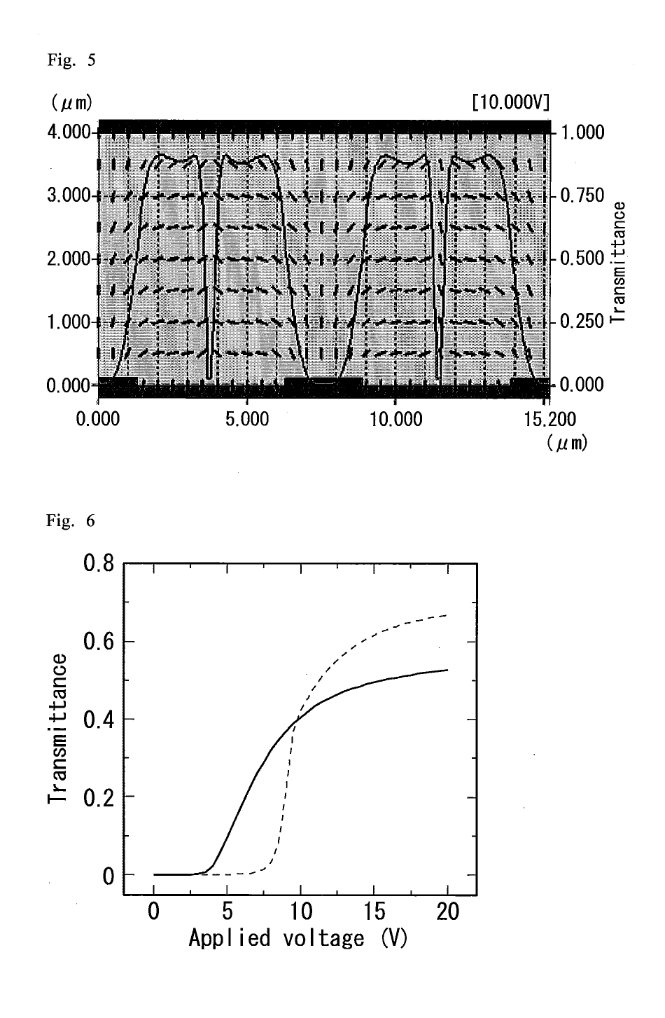

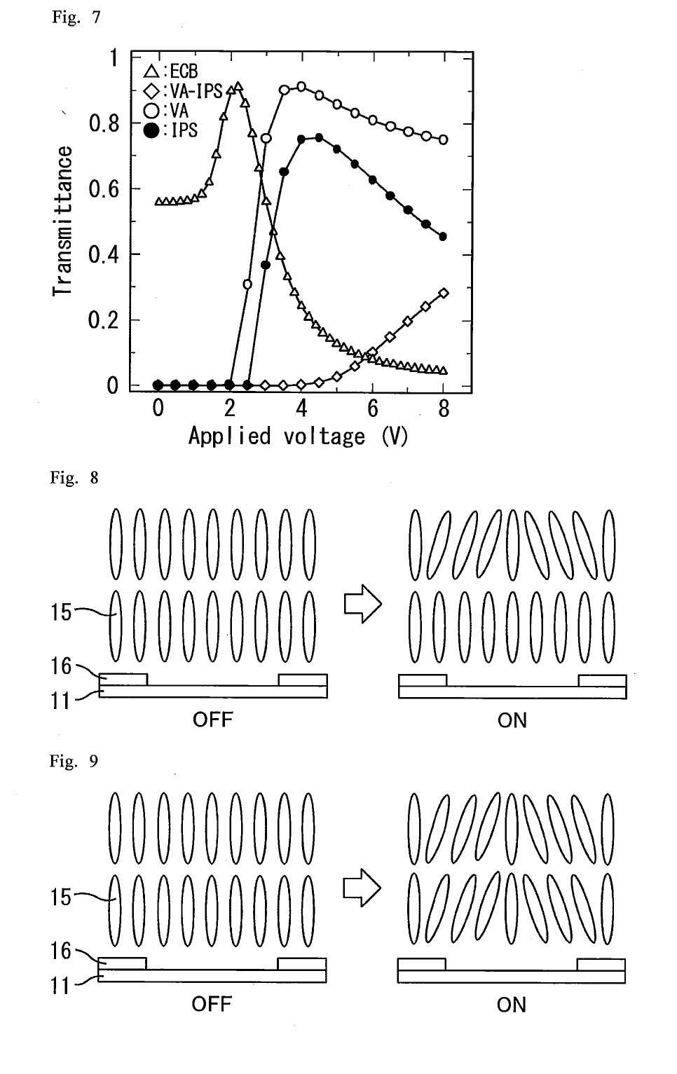

Application of a certain voltage to a pair of comb-shaped electrodes generates an arch-shaped electric field in a liquid crystal layer. Then, p-type nematic liquid crystal molecules are bend-aligned along the applied electric field. In an electrode forming part and a central part between electrodes, vertical alignment is maintained, and liquid crystal molecules located in a non-electrode portion contribute to transmittance. Therefore, the direction of the electric field, alignment of liquid crystal molecules, transmittance distribution, and the like in the liquid crystal layer of the liquid crystal display element of Embodiment 1 exhibit the same tendency as shown in FIGS. 2 to 5.

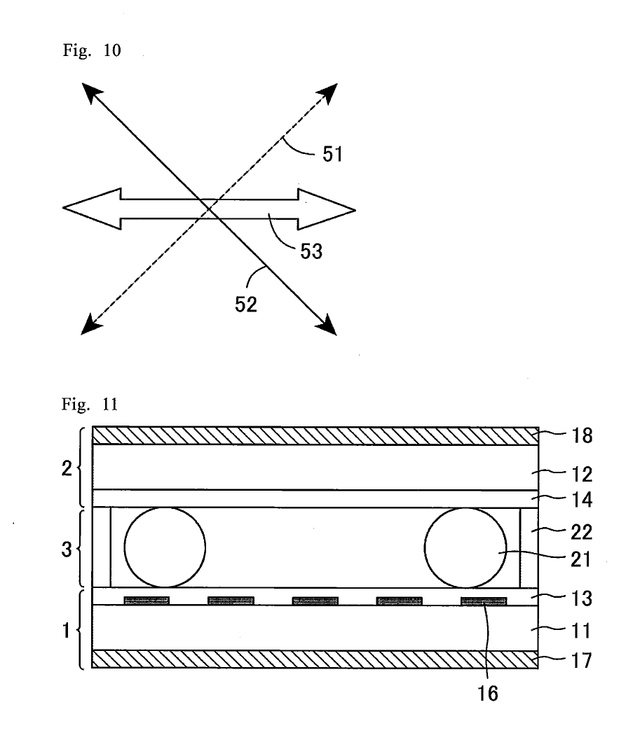

Polarizers 17 and 18 are disposed, respectively, on faces of the transparent substrates 11 and 12 opposite to the liquid crystal layer 3. FIG. 10 is a view schematically showing the relationship between an electric field direction of a liquid crystal display element and a transmission axis of a polarizer according to Embodiment 1. A dashed line arrow is a transmission axis 51 of the polarizer on an array substrate side, and a solid line arrow is a transmission axis 52 of the polarizer on a counter substrate side. In addition, a hollow arrow shows a direction 53 of an applied electric field. As shown in FIG. 10, the transmission axis 51 of the polarizer on the array substrate side and the transmission axis 52 of the polarizer on the counter substrate side have a cross-Nicole relationship to mutually form an angle of substantially 90°. In addition, each of these transmission axes is adjusted to form an angle of substantially 45° to a direction of the electric field, that is, a direction orthogonal to a length direction of each comb tooth of a pair of comb-shaped electrodes 16 (direction of an applied electric field). As a result, in no voltage application, light directly transmits through the liquid crystal layer, and is intercepted by a polarizer. In contrast, when a threshold or higher voltage is applied, the liquid crystal layer induces light birefringence, and the light transmits through the polarizer.

FIG. 11 is a cross-sectional view schematically showing the liquid crystal display element according to Embodiment 1. The liquid crystal display element of Embodiment 1 has, between an array substrate 1 and a counter substrate 2, a bead spacer 21 defining the thickness of the liquid crystal layer 3 (cell gap) and a sealing member 22 for sealing the liquid crystal layer 3.

The following describes the actual production of the liquid crystal display element of Embodiment 1 and the results of evaluating the liquid crystal display element compared with a conventional one. Specifically, the liquid crystal display element of Embodiment 1 was produced as follows.

First, a glass substrate on an array substrate side was prepared, the glass substrate including a pair of ITO (Indium Tin Oxide)-made comb-shaped electrodes on its surface. Subsequently, a polyimide solution for a vertical alignment film (5% by weight, NMP solution) having a chemical structure shown by the formula (1) was applied to the glass substrate and the pair of comb-shaped electrode by a spin coat method. Then, the solution-coated substrate was fired at 200° C. for 1 hour to form a polymer film. The fired polymer film had a thickness of 600 Å. The width of each of the comb teeth of the pair of comb-shaped electrodes was 4 μm, and the interval between each of the comb teeth was 4 μm.

Next, a polymer film was also formed on a glass substrate on a counter substrate side in the same process. Thereafter, 4-micron resin beads (trade name: Micropearl SP, Sekisui Chemical Co., Ltd.) were dispersed on an array substrate, and seal resins (trade name: Structbond XN-21-S, produced by Mitsui Chemicals, Inc.) were printed on the counter substrate. Then, these were laminated, and fired at 250° C. for 3 hours to produce a liquid crystal cell. Note that the cell gap was 4 μm.

Then, a liquid crystal composition (produced by Merck & Co., Inc.) was enclosed in the liquid crystal cell by a vacuum injection method. Thereafter, a polarizer was laminated on the face opposite to the liquid crystal layer of each glass substrate to produce a liquid crystal display element (Example 1). FIG. 10 shows the relationship between the direction of an applied electric field and the direction of a polarizer axis. An of the liquid crystal composition (produced by Merck & Co., Inc.) enclosed between the pair of substrates was 0.112, and As thereof was 18.5.

Lastly, voltage-transmittance characteristics of the liquid crystal display element of Example 1 were determined using a liquid crystal evaluation device LCD-5200 (produced by Otsuka Electronics Co., Ltd.).

A liquid crystal display element for comparison (Comparative Example 1) was produced by the same method as in Example 1, except that a polyimide solution for a vertical alignment film (5% by weight, NMP solution) in which the material of the polymer film had a chemical structure of formula (2) was used. Voltage-transmittance characteristics were determined similarly as in Example 1.

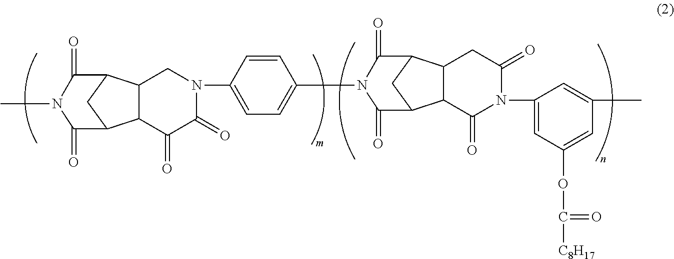

(In the formula, m and n each represent the number of the repeated structures in the parenthesis, and are each a positive integer. In addition, n=4 m.)

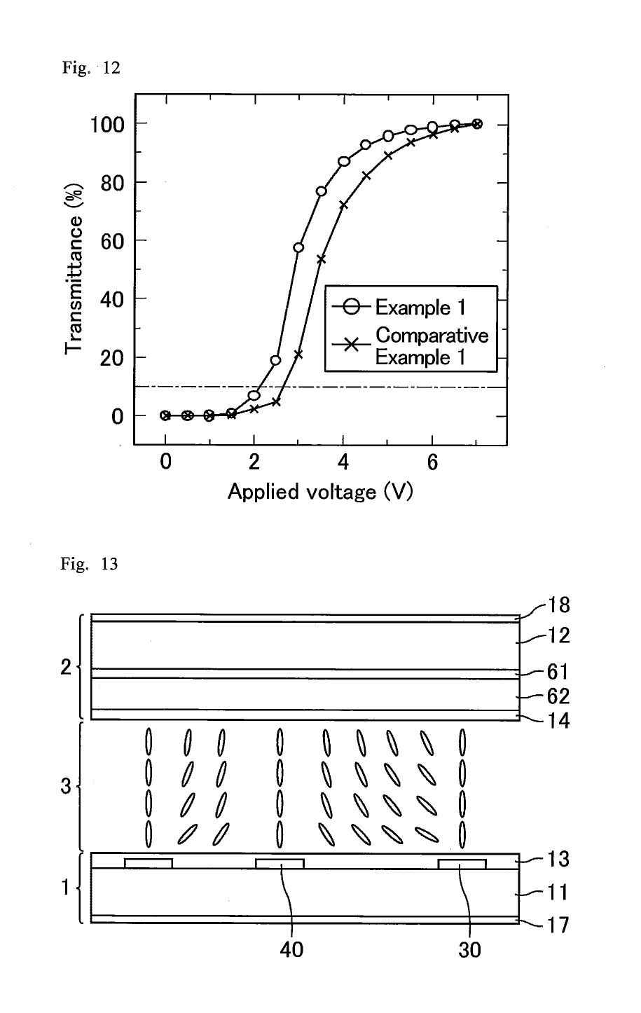

FIG. 12 is a graph showing voltage-transmittance characteristics of liquid crystal elements of Example 1 and Comparative Example 1 at room temperature. With respect to an index for evaluating the effect of threshold voltage reduction, a voltage, which is required to give a transmittance of 10% provided that the maximum transmittance of the liquid crystal display element is 100%, is hereinafter defined as a threshold voltage “V10”. The V10 of the liquid crystal display element of Example 1 was 2.13 V, and the V10 of the liquid crystal display element of Comparative Example 1 was 2.66 V.

FIG. 12 shows that in the liquid crystal display element of Example 1, the threshold voltage V10 can be reduced by 0.5 V or more without impairing transmittance characteristics, and the practical value is high.

Subsequently, liquid crystal display elements as evaluation objects were produced by the same method as in Example 1 in order to investigate the influence of the F atom content in the polymer material in the polymer film of the liquid crystal display elements of Embodiment 1. Specifically, liquid crystal display elements (Examples 2 to 5 and Comparative Example 1) in which the content of formula (1) and the content of formula (2) are different from one another in the polymer material were produced. Table 2 summarizes the results of the respective examples and comparative examples.

TABLE 2

| | Content of | Content of | F atom | |
|---|---|---|---|---|
| | formula (1) (%) | formula (2) (%) | content (%) | V10 (V) |
| Example 1 | 100 | 0 | 11.6 | 2.13 |
| Example 2 | 80 | 20 | 9.2 | 2.13 |
| Example 3 | 60 | 40 | 6.9 | 2.14 |
| Example 4 | 40 | 60 | 4.6 | 2.44 |
| Example 5 | 20 | 80 | 2.3 | 2.55 |
| Comparative | 0 | 100 | 0 | 2.66 |
| Example 1 | | | | |

Table 2 shows that as F atom content increases, the threshold voltage decreases; and particular when the F atom content per repeating unit of the polymer material is 5% by weight or more (Examples 1 to 3), the effect of threshold voltage reduction can be remarkably exerted.

The F atom content was calculated from the formula: “content of an F atom-containing polymer”×“F atom content in a repeating unit of the F atom-containing polymer”. In order to analyze the F atom content, Fourier Transform Infrared Spectroscopy (FT-IR) and X-ray Photoelectron Spectroscopy (XPS) were used.

### Embodiment 2

A liquid crystal display element of Embodiment 2 has the same configuration as the liquid crystal display element of Embodiment 1, except that a polymer film provided at an interface with a liquid crystal layer has a different configuration. In Embodiment 2, the polymer film (alignment film) has a CF₂ bond in a side chain, and is made of a polymer material having a CF₃ group in a side chain end.

Specifically, the liquid crystal display element of Embodiment 2 was produced as follows.

First, a glass substrate on an array substrate side was prepared, the glass substrate including a pair of ITO-made comb-shaped electrodes on its surface. Subsequently, the glass substrate and the pair of comb-shaped electrodes were immersed in a 0.01 mol/l chloroform-NMP mixed solution (chloroform:NMP=1:10) of a silane coupling agent shown by formula (3) for 5 minutes, and then dried under dry nitrogen at 120° C. for 1 hour to form a polymer film. The width of the each of the comb teeth of a pair of comb-shaped electrodes was 4 μm, and the interval between each of the comb teeth was 4 μm.

CF₃—(CF₂)₁₇—SiCl₃ (3)

Next, an identical polymer film was also formed on a glass substrate on a counter substrate side in the same process. Thereafter, 4-micron resin beads (trade name: Micropearl SP, Sekisui Chemical Co., Ltd.) were dispersed on an array substrate, and seal resins (trade name: Structbond XN-21-S, produced by Mitsui Chemicals, Inc.) were printed on the counter substrate. Then, these were laminated, and fired at 250° C. for 3 hours to produce a liquid crystal cell. Note that the cell gap was 4 μm.

Then, a liquid crystal composition (produced by Merck & Co., Inc.) was enclosed in the liquid crystal cell by a vacuum injection method. Thereafter, a polarizer was laminated on the face opposite to the liquid crystal layer of each glass substrate to produce a liquid crystal display element (Example 6). FIG. 10 shows the relationship between the direction of an applied electric field and the direction of a polarizer axis. Δn of the liquid crystal composition (produced by Merck & Co., Inc.) enclosed between the pair of substrates was 0.112, and Δ∈ thereof was 18.5.

Lastly, voltage-transmittance characteristics of the liquid crystal display element were determined as in Example 1. As a result, the V10 of the liquid crystal display element of Example 6 was 2.06 V, and the drive voltage was substantially reduced. F atom content per repeating unit of the polymer material in the polymer film of the liquid crystal display element of Example 6 was 52.5% by weight.

The thus-produced polymer film of the liquid crystal display element of Example 6 is a monomolecular adsorption film. In addition, the mere immersion in a solution enables to give a uniform polymer film as shown in the above process. Therefore, in comparison with the case of the liquid crystal display elements of Examples 1 to 5, a liquid crystal display element can be produced by a simpler film formation process.

In major display modes other than the VA-IPS mode, it is necessary to give a certain or higher level of pre-tilt (initial inclination) angle characteristics to a polymer film, and it is not easy to control pre-tilt angles of liquid crystal molecules by a monomolecular adsorption film. In the VA-IPS display mode, it is not necessary to precisely control the pre-tilt angles of liquid crystal molecules. Therefore, a method of forming the above monomolecular adsorption film is well matched with the VA-IPS display mode. In addition, the monomolecular adsorption film is a molecular-level superthin film, and an alignment film causes a small voltage loss. Accordingly, the monomolecular adsorption film is suitable for the VA-IPS display mode.

### Embodiment 3

A liquid crystal display element of Embodiment 3 has the same configuration as the liquid crystal display element of Embodiment 1, except that a polymer film provided at an interface with a liquid crystal layer has a different configuration. In Embodiment 3, the polymer film (alignment film) is made of a polymer material having a CF₂ bond.

Specifically, the liquid crystal display element of Embodiment 3 was produced as follows.

First, a glass substrate on an array substrate side was prepared, the glass substrate including a pair of ITO-made comb-shaped electrodes on its surface. Subsequently, a polyimide material obtained by mixing a polyimide material with high anchoring energy and a fluorinated material with low anchoring energy at a predetermined ratio was prepared, and a polymer film (LB (Langmuir-Blodgett) film) was formed on the glass substrate and the pair of comb-shaped electrodes by the LB method.

A method of preparing the polyimide material will be described in detail hereinafter. First, 5 mmol of tetra carboxylic anhydride of formula (4) and 5 mmol of diamine of formula (5) were agitated in 20 ml of dehydrated N,N-dimethylacetamide at 25° C. for 3 hours to be condensation-polymerized, whereby polyamide acid of formula (6) was produced.

Then, the polyamide acid of formula (6) and N,N-dimethylhexadecylamine of formula (7) were reacted in a mixed solution of N,N-dimethylacetamide and benzene (a mixing ratio (a volume ratio) of N,N-dimethylacetamide:benzene=1:1), and thereby an alkylamine salt of the polyamide acid of formula (8) was produced and built up on each of the substrates. Build-up conditions were as follows: a surface pressure of 15 mN/m; a pulling rate of 15 ram/min; and a build-up temperature of 20° C.

Subsequently, these built-up films produced by the above method were immersed in a mixed solution of acetic anhydride, pyridine, and benzene (a mixing ratio (a volume ratio) of acetic anhydride:pyridine:benzene=1:1:3) in each of the substrates for 12 hours, whereby built-up films (alignment films) of polyimide (hereinafter, abbreviated as PI) of formula (9) were produced.

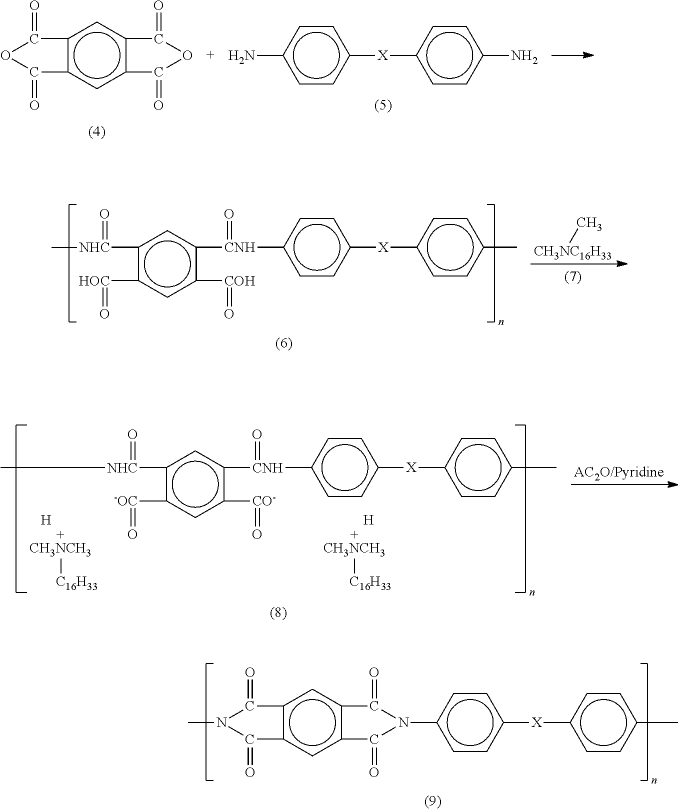

(In the formula, X represents C(C₃H₈—C₆H₄—C₂H₅)₂. In addition, n represents the number of the repeated structures in the parenthesis, and is a positive integer.)

Using perfluoro polyether (hereinafter, abbreviated as PFPE) of formula (10) as a fluorinated material, a fluorinated film was formed on a glass substrate and a pair of electrodes by the LB method in the same manner as described above.

HO—CH₂—CF₂O—(CF₂—CF₂—O)ₘ—(CF₂—O)ₙ—CF₂—CH₂—OH (10)

(In the formula, m and n each represent the number of the repeated structures in the parenthesis, and are each a positive integer.)

In this case, substrates were prepared having polymer films in which the amounts of the polyimide material (PI) and the fluorinated material (PFPE) were different from one another and which differed in F atom content. Thereafter, liquid crystal display elements (Examples 7 to 11) were produced by the same method as in Example 1, and voltage-transmittance characteristics were determined similarly as in Example 1. Table 3 summarizes the results of the respective liquid crystal display elements.

TABLE 3

| | PI content | PEPE | F atom | |
|---|---|---|---|---|
| | (%) | content (%) | content (%) | V10 (V) |
| Example 7 | 80 | 5 | 3.2 | 2.6 |
| Example 8 | 60 | 8 | 5.0 | 2.2 |
| Example 9 | 40 | 10 | 6.3 | 2.1 |
| Example 10 | 20 | 17 | 10.7 | 1.9 |
| Example 11 | 0 | 20 | 12.5 | 1.8 |

Table 3 shows that as F atom content increases, the threshold voltage decreases; and particular when F atom content per repeating unit of the polymer material is 5% by weight or more (Examples 8 to 11), the effect of threshold voltage reduction can be remarkably exerted. In addition, when the F atom content per repeating unit of the polymer material is 10% by weight or more (Examples 10 and 11), voltage-transmittance characteristics are moderate and gradation display performance is good.

### Embodiment 4

A liquid crystal display element of Embodiment 4 has the same configuration as the liquid crystal display element of Embodiment 1, except that a nano-order irregularity structure is provided on the surface of a polymer film provided at an interface with a liquid crystal layer on a counter substrate side, and that the polymer film provided at the interface with the liquid crystal layer on the counter substrate side has a different configuration.

Specifically, the liquid crystal display element of Embodiment 4 was produced as follows.

First, a glass substrate on the counter substrate side was prepared. Then, the surface of the glass substrate was irradiated with ion beams under conditions of an radiation energy of 2000 eV, a radiation time of 120 seconds, and a radiation angle of 45° to form an irregularity structure with a depth of 50 nm (RMS) and a pitch of 100 nm between depressions. Note that RMS stands for Root Mean Square, and is a value obtained by finding the square root of the arithmetic mean of the squares.

Next, a chemical adsorption film containing a compound of formula (3) in Embodiment 2 was formed on the surface of the glass substrate, and thereafter a liquid crystal display element (Example 12) was produced by the same method as in Example 6.

Then, voltage-transmittance characteristics of the liquid crystal display element of Example 12 were also determined, and the V10 of the liquid crystal display element of Example 12 was 1.9 V. Thus, in Embodiment 4, the drive voltage can be reduced only by adjusting the counter substrate (not the array substrate) side, and the practical value is very high.

The results of other measurements show that the critical surface energy between the chemical adsorption film and liquid crystal layer, which were formed on the glass substrate having the above irregularity structure on the surface, was 6.3 N/m, and the critical surface energy between the chemical adsorption film and liquid crystal layer, which were formed on the glass substrate having a flat surface, was 8.6 N/m. Thus, reduction in critical surface energy and reduction in anchoring energy cause reduction in threshold voltage.

### Embodiment 5

A liquid crystal display element of Embodiment 5 has the same configuration as the liquid crystal display element of Embodiment 1, except that a polymer film provided at an interface with a liquid crystal layer is an inorganic alignment film OA-018 (produced by Nissan Chemical Industries, Ltd.). In Embodiment 5, the polymer film (alignment film) is made of a polymer material having an SiO bond.

A liquid crystal display element (Example 13) was produced by the same method as in Example 1, except that the polymer film was made of the above material. Voltage-transmittance characteristics were determined similarly as in Example 1, and V10=2.31 V.

Using an organic alignment film SE-1211 (produced by Nissan Chemical Industries, Ltd.) not having an SiO bond as a material of the polymer film, a liquid crystal display element was produced by the same method as in Example 1 (Comparative Example 2). Voltage-transmittance characteristics were determined as in Example 1, and V10=2.73 V.

The results show that use of a material having an SiO bond as a material of the polymer film enables to substantially reduce the anchoring energy in comparison with a usual polyimide alignment film, resulting in the effect of reducing the drive voltage.

The analysis of the liquid crystal display element of Example 13 by Fourier transform infrared spectroscopy (FT-IR method) and X-ray photoelectron spectroscopy (XPS method) as in Example 1 shows that Si atom content per repeating unit in the polymer material was 6.2% by weight.

### Embodiment 6

A liquid crystal display element of Embodiment 6 has the same configuration as the liquid crystal display element of Embodiment 1, except that a polymer film provided at an interface with a liquid crystal layer has a different configuration. In Embodiment 6, the polymer film (alignment film) is made of a polymer material having an SiO bond.

Specifically, the liquid crystal display element of Embodiment 6 was produced as follows.

First, a mixture of 21.8 g of tetraethoxysilane and 5.5 g of tridecafluorooctyltrimethoxysilane was added dropwise to a mixed solution of 52.3 g of ethanol and 20.5 g of oxalic acid under reflux, and refluxed for 5 hours. Thereafter, 75 g of butyl cellosolve was added to the resultant mixture to prepare a polysiloxane solution having an SiO₂ concentration of 4% by weight.

Next, the prepared polysiloxane solution was film-formed on a glass substrate by a spin coat method, thereafter left to stand at 60° C. for 30 minutes, and then fired at 250° C. for 1 hour to form a polymer film (alignment film). The dried polymer film had a thickness of 100 nm. With respect to other configurations, a liquid crystal display element (Example 14) was produced as in Example 1, and voltage-transmittance characteristics were determined at room temperature. The results prove that the V10 of the liquid crystal display element of Example 14 was 2.18 V, and a significant reduction in drive voltage was obtained.

The chemical analysis of the liquid crystal display element of Example 14 shows that Si atom content per repeating unit in the polymer material was approximately 8% by weight. This led to reduction in anchoring energy, resulting in reduction in drive voltage. As a result, the threshold voltage is presumed to decrease as Si content is increased. Therefore, the Si content is preferably 5 to 30% by weight in terms of both film formation and alignment.

### Embodiment 7

A liquid crystal display element of Embodiment 7 has the same configuration as the liquid crystal display element of Embodiment 1, except that a nano-order irregularity structure is provided on the surface of a polymer film provided at an interface with a liquid crystal layer, and that the polymer film provided at the interface with the liquid crystal layer has a different configuration.

Specifically, the liquid crystal display element of Embodiment 7 was produced as follows.

First, a glass substrate was prepared. Then, the surface of the glass substrate was irradiated with focused ion beams (radiation time: 120 seconds, radiation angle: 45°) and modified to form an irregularity structure with a depth of several tens nm and a pitch of several tens nm between depressions. Here, using multiple glass substrates having different depth and pitch orders in irregularity structure and having the same other configurations as in Example 1, multiple crystal display elements (Examples 15 to 18 and Comparative Example 3 and 4) having different orders in irregularity structures formed on the surface of each polymer film were produced as in Example 1.

Voltage-transmittance characteristics of these liquid crystal display elements were determined at room temperature by the same method as in Example 1, and the results shown in Table 4 were obtained.

TABLE 4

| | Radiation | Depth | Threshold | Vertical |
|---|---|---|---|---|
| | energy (eV) | (RMS) (nm) | voltage V10 (V) | alignment |
| Comparative | 1200 | 3 | — | Not |
| Example 3 | | | | aligned |
| Example 15 | 1500 | 10 | 2.04 | Good |
| Example 16 | 1800 | 50 | 1.91 | Good |
| Example 17 | 2100 | 82 | 1.80 | Good |
| Example 18 | 2400 | 100 | 1.65 | Good |
| Comparative | 2700 | 122 | 1.64 | Good |
| Example 4 | | | | |

When the surface of a silicon nitride (CNx) film (polymer film) of each liquid crystal display element (Examples 15 to 18 and Comparative Example 3 and 4) was observed using a surface roughness meter (trade name: New View 5032, produced by ZYGO), nanoscale fine depressions and holes were found. According to such a shape effect, anchoring energy can be reduced by one or more digits smaller than that of an organic alignment film with a flat surface.

A polymer film material is not limited to silicon nitride (CNx) mentioned in the above example, and may be other inorganic dielectrics such as AlOx, SiOx, TiOx, HfOₓ, SiC, and DLC (Diamondlike Carbon). In Embodiment 7, a polymer film may be a laminated film of these inorganic dielectrics, and be an appropriate combination of an AlOx film and an HfOₓ film, and the like.

In each of the above examples and comparative examples, fine irregularities on a substrate surface impart vertical alignment to liquid crystal molecules, and a change in the chemical structure (reduction in bond energy) caused by ion beam irradiation also contributes to improvement in vertical alignment.

Here, when the depth of each irregularity on the substrate surface was less than 10 nm (Comparative Example 3), uniform vertical alignment of liquid crystal molecules were not obtained. Even when the depth exceeded 100 nm (Comparative Example 4), good alignment of liquid crystal molecules were obtained. However, since the effect of threshold voltage reduction is saturated, the depth is practically preferably 10 nm or more but 100 nm or less.

Embodiments 1 to 7 described above may be combined with one another, and each of the above polymer films may be laminated. In addition, the polymer film may contain Al (aluminium), Ga (gallium), In (indium), Si (silicon), Ge (germanium), Sn (tin), Ti (titanium), Zr (zirconium), and Hf (hafnium), whereby more anchoring energy can be reduced.

### Embodiment 8

FIG. 13 is a cross-sectional schematic view showing the configuration of a liquid crystal display element according to Embodiment 8. As shown in FIG. 13, the liquid crystal display of Embodiment 8 is provided with a liquid crystal display panel including a liquid crystal layer 3 and a pair of substrates 1 and 2 that sandwich the liquid crystal layer 3. One of the pair of substrates is an array substrate 1, and the other is a counter substrate 2. The liquid crystal display element of Embodiment 8 has the same configuration as the liquid crystal display element of Embodiment 1, except that it has a counter electrode 61 on the counter substrate 2 side. As shown in FIG. 13, a counter electrode 61, a dielectric layer (an insulating layer) 62, and a polymer film (alignment film) 14 are laminated on a liquid crystal layer-side main surface of a transparent substrate (an upper substrate) 12 included in the counter substrate 2. A color filter layer may be provided between the counter electrode 61 and the transparent substrate 12.

The counter electrode 61 includes a transparent conductive film including, e.g., ITO or IZO. The counter electrode 61 and the dielectric layer 62 are formed so as to cover at least the entire display region in a seamless manner, respectively. A predetermined potential common to the respective pixels is applied to the counter electrode 61.

The dielectric layer 62 includes a transparent insulating material. Specifically, this layer includes, e.g., an inorganic insulating film such as a silicon nitride, or an organic insulating film such as an acrylic resin.

On the other hand, on a main surface of a transparent substrate 11 on the liquid crystal layer 13 side included in the array substrate 1, a comb-shaped electrode including a pixel electrode 30 and a common electrode 40 and a polymer film (alignment film) 13 are provided. Moreover, polarizers 17 and 18 are disposed on outer main surfaces of the two transparent substrates 11 and 12.

Unless black display appears, different voltages are applied between the pixel electrode 30 and the common electrode 40 and between the pixel electrode 30 and the counter electrode 61. The common electrode 40 and the counter electrode 61 may be grounded; the common electrode 40 and the counter electrode 61 may be supplied with voltages having the same intensity and the same polarity, or may be supplied with voltages having different intensities and different polarities.

The liquid crystal display element of Embodiment 8 can be driven at a low threshold voltage. Further, formation of the counter electrode 61 can increase a response speed.

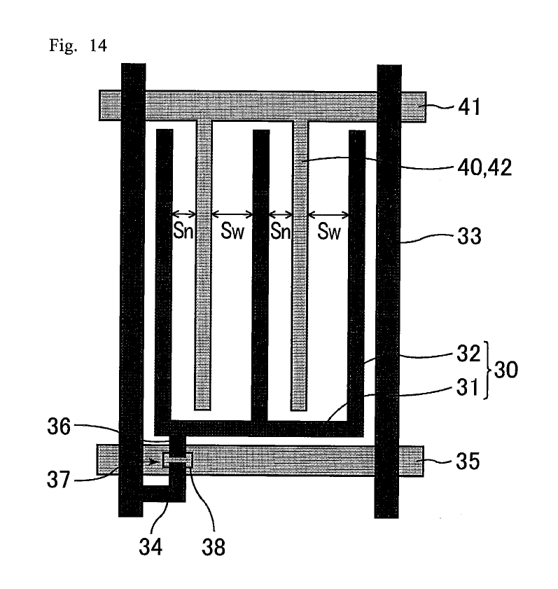

FIG. 14 is a plan schematic view showing the configuration of the liquid crystal display element according to Embodiment 8. The characteristics of Embodiment 8 shown in FIG. 14 may be applicable to Embodiments 1 to 7. The pixel consists of sub-pixels with multiple colors. Note that the pixel may not consist of sub-pixels with multiple colors; that is, the liquid crystal display element according to the present embodiment may be presented through black and white presentations. The following configuration is represented in terms of a pixel, in this case. When the liquid crystal display element is seen from the front side, i.e., when the pair of substrate surfaces are seen from the front side, a 3-o'clock direction, a 12-o'clock direction, a 9-o'clock direction, and a 6-o'clock direction are determined as a 0° direction (azimuth), a 90° direction (azimuth), a 180° direction (azimuth), and a 270° direction (azimuth), respectively; the direction passing through the 3-o'clock position and the 9-o'clock position is determined as a horizontal direction, and the direction passing through the 12-o'clock position and the 6-o'clock position is determined as a vertical direction.

On a main surface of the transparent substrate 11 on the liquid crystal layer 3 side are provided signal lines 33, scanning lines 35, a common wiring 41, thin-film transistors (TFTs) 37 that are switching elements (active elements) and individually provided for each sub-pixel, the pixel electrode 30 individually provided for each sub-pixel, and the common electrode 40 provided in common to multiple sub-pixels (e.g., all sub-pixels).

The scanning lines 35, the common wiring 41, and the common electrode 40 are provided on the transparent substrate 12. On the scanning lines 35, the common wiring line 41, and the common electrode 40, a gate insulating film (not shown) is provided. The signal lines 33 and the pixel electrode 30 are provided on the gate insulating film. On the signal lines 33 and the pixel electrode 30, the polymer film (alignment film) 13 is provided.

The common wiring 41, the common electrode 40, and the pixel electrode 30 may be patterned by photolithography using the same film in the same process, and may be disposed on the same layer (the same insulating film).

The signal lines 33 are linearly provided in parallel to each other and extend in the vertical direction between pixels adjacent to each other. The scanning lines 35 are linearly provided in parallel to each other and extend in the horizontal direction between pixels adjacent to each other. Each signal line 33 and each scanning line 35 are orthogonal to each other, and a region defined by the signal lines 33 and the scanning lines 35 serves as substantially one pixel region. The scanning line 35 also functions as a gate of the TFT 37 in the display region.

The TFT 37 is provided near an intersecting portion of the signal line 33 and the scanning line 35 and includes a semiconductor layer 38 formed into an island shape on the scanning line 35. Further, the TFT 37 has a source electrode 34 that functions as a source and a drain electrode 36 that functions as a drain. The source electrode 34 connects the TFT 37 to the signal line 33, and the drain electrode 36 connects the TFT 37 to the pixel electrode 30. The source electrode 34 and the signal line 33 are pattern-formed from the same film, whereby these members are connected to each other. The drain electrode 36 and the pixel electrode 30 are pattern-formed from the same film, whereby these members are connected to each other.

The signal line 33 supplies a pixel signal to the pixel electrode 30 at predetermined timings when the TFT 37 is in an ON state. On the other hand, a predetermined potential common to the respective pixels is applied to the common wiring line 41 and the common electrode 40.

The pixel electrode 30 has a comb shape in plan, and the pixel electrode 30 has a linear base portion (a pixel base portion 31) and multiple linear comb-tooth portions (pixel comb-tooth portions 32). The pixel base portion 31 is provided along a short side (a lower side) of the pixel. The respective pixel comb-tooth portions 32 are connected to the pixel base portion 31. Moreover, the respective pixel comb-tooth portions 32 extend toward the opposite short side (the upper side) from the pixel base portion 31, i.e., in the substantially 90° direction.

The common electrode 40 includes a comb shape in a plan view, and it has multiple linear comb teeth (common comb-tooth portions 42). The common comb-tooth portions 42 and the common wiring 41 may be pattern-formed from the same film, whereby these members are connected to each other. That is, the common wiring 41 also serves as a base portion (a common base portion) of the common electrode 40 that connects the common comb-tooth portions 42 to each other. The common wiring 41 is linearly provided in parallel to the scanning line 35 and extend in the horizontal direction between pixels adjacent to each other. The common comb-tooth portions 42 extend toward the opposite lower side of the pixel from the common wiring 41, i.e., in the substantially 270° direction.

As described above, the pixel electrode group 30 and the common electrode group 40 are oppositely arranged so that their comb teeth (the pixel comb-tooth portions 32 and the common comb-tooth portions 42) mesh with each other. Additionally, the pixel comb-tooth portions 32 and the common comb-tooth portions 42 are arranged in parallel to each other, and they are also alternately arranged at intervals.

Further, in the example shown in FIG. 14, a single pixel has two domains having opposite tilt directions of the liquid crystal molecules. The number of the domains is not particularly restricted and may be appropriately set. Four domains may be formed in one pixel in view of acquiring good viewing angle characteristics.

Furthermore, in the example shown in FIG. 14, a single pixel has two or more regions having different electrode spacings. In more detail, each pixel has regions having a relatively narrow electrode spacing (regions with a spacing Sn) and regions having a relatively wide electrode spacing (regions with a spacing Sw). Thus, the respective regions can have different threshold values of VT characteristics, and a gradient of the VT characteristics in the entire pixel particularly at low tones can be made mild. As a result, occurrence of white-floating can be suppressed and the viewing angle characteristics can be improved. The white-floating means a phenomenon that an image which should be darkly displayed is rendered whitely when an observing direction is inclined from the front side to an oblique direction in a state that a relatively dark image at low tones is displayed.

The present application claims priority to Patent Application No. 2009-175704 filed in Japan on Jul. 28, 2009 and Patent Application No. 2010-006690 filed in Japan on Jan. 15, 2010 under the Paris Convention and provisions of national law in a designated State, the entire contents of which are hereby incorporated by reference.

### EXPLANATION OF NUMERALS AND SYMBOLS

1: Array substrate
2: Counter substrate
3: Liquid crystal layer
11, 12: Transparent substrate
13, 14: Polymer film (alignment film)
15: Liquid crystal molecule
16: Comb-shaped electrode
17, 18: Polarizer
21: Spacer
22: Sealing member
30: Pixel electrode
31: Pixel base portion
32: Pixel comb-tooth portion
33: Signal line
34: Source electrode
35: Scanning line
36: Drain electrode
37: TFT
38: Semiconductor layer
40: Common electrode
41: Common wiring (common base portion)
42: Common comb-tooth portion
51: Transmission axis of the polarizer on an array substrate side
52: Transmission axis of the polarizer on a counter substrate side
53: Direction of an applied electric field
61: Counter electrode
62: Dielectric layer

1. A liquid crystal display element, comprising:
a pair of substrates; and
a liquid crystal layer sealed between the pair of substrates,
wherein the liquid crystal layer contains liquid crystal molecules that are aligned perpendicularly to at least one substrate face of the pair of substrates when no voltage is applied,
the at least one of the pair of substrates comprises a pair of comb-shaped electrodes,
the at least one of the pair of substrates comprises a polymer film on a face contacting the liquid crystal layer, and
the polymer film is made of a polymer material having a CF₂ bond.

2. A liquid crystal display element, comprising:
a pair of substrates; and
a liquid crystal layer sealed between the pair of substrates,
wherein the liquid crystal layer contains liquid crystal molecules that are aligned perpendicularly to at least one substrate face of the pair of substrates when no voltage is applied,
the at least one of the pair of substrates comprises a pair of comb-shaped electrodes,
the at least one of the pair of substrates comprises a polymer film on a face contacting the liquid crystal layer, and
the polymer film is made of a polymer material having a CF₃ bond in a side chain end.

3. The liquid crystal display element according to claim 1,
wherein F atom content per repeating unit of the polymer material is 5% by weight or more.

4. A liquid crystal display element, comprising:
a pair of substrates; and
a liquid crystal layer sealed between the pair of substrates,
wherein the liquid crystal layer contains liquid crystal molecules that are aligned perpendicularly to at least one substrate face of the pair of substrates when no voltage is applied,
the at least one of the pair of substrates comprises a pair of comb-shaped electrodes,
the at least one of the pair of substrates comprises a polymer film on a face contacting the liquid crystal layer, and
the polymer film is made of a polymer material having an SiO bond.

5. The liquid crystal display element according to claim 4,
wherein Si atom content per repeating unit of the polymer material is 5% by weight or more.

6. A liquid crystal display element, comprising:
a pair of substrates; and
a liquid crystal layer sealed between the pair of substrates,
wherein the liquid crystal layer contains liquid crystal molecules that are aligned perpendicularly to at least one substrate face of the pair of substrates when no voltage is applied,
the at least one of the pair of substrates comprises a pair of comb-shaped electrodes,
the at least one of the pair of substrates comprises a polymer film on a face contacting the liquid crystal layer, and
the polymer film is made of an inorganic material and comprises, on its surface, multiple depressions each having a depth of 10 nm or more but 100 nm or less.

7. The liquid crystal display element according to claim 1,
wherein the liquid crystal molecules are nematic liquid crystal molecules having positive dielectric anisotropy.
